(19) United States
(12) Patent Application Publication
(10) Pub. No.: US 2025/0123597 A1
(43) Pub. Date: Apr. 17, 2025

(54) ELECTRONIC TIMEPIECE

(71) Applicant: CASIO COMPUTER CO., LTD., Tokyo (JP)

(72) Inventors: Junyuan ZHANG, Tokyo (JP); Yuta SAITO, Tokyo (JP); Fumiaki OCHIAI, Tokyo (JP); Naoto FUKUSHIMA, Tokyo (JP); Yoshinori ASAMI, Tokyo (JP)

(21) Appl. No.: 18/916,184

(22) Filed: Oct. 15, 2024

(30) Foreign Application Priority Data
Oct. 16, 2023 (JP) 2023-178120

(51) Int. Cl. G04G 17/02; G04C 10/02; G04G 21/04

(52) U.S. Cl. CPC G04G 17/02; G04C 10/02; G04G 21/04

(57) ABSTRACT

An electronic timepiece includes, a first substrate that includes a plurality of first connection terminals, a processor, and a selector that switches a connection between the first connection terminals and the processor, and a second substrate that includes a plurality of second connection terminals that are connected to a plurality of peripheral devices that each perform a certain operation. Each of the second connection terminals is connected to each of the first connection terminals. The selector switches the first connection terminal that is connected to the processor based on control by the processor.

### CROSS-REFERENCE TO RELATED APPLICATIONS

This application claims the benefit of Japanese Patent Application No. 2023-178120, filed Oct. 16, 2023 which is hereby incorporated by reference wherein in its entirety.

### BACKGROUND OF THE INVENTION

### Field of the Invention

The present disclosure relates to an electronic timepiece.

### Description of the Related Art

For example, as disclosed in JP 2022-11394, there is conventional technology to share a motor control substrate and a main control substrate in a cleaner and a blower by switching a motor operation depending on whether there is a trigger switch present only in the blower.

### SUMMARY OF THE INVENTION

In order to solve the above problems, the electronic timepiece of the present invention includes: a first substrate that includes a plurality of first connection terminals, a processor, and a selector that switches a connection between the first connection terminals and the processor, and a second substrate that includes a plurality of second connection terminals that are connected to a plurality of peripheral devices that each perform a certain operation, wherein, each of the second connection terminals is connected to each of the first connection terminals, and the selector switches the first connection terminal that is connected to the processor based on control by the processor.

The effect of this invention is that it is possible to reduce a burden required to change a design of a control substrate in an electronic timepiece.

Further features of the present invention will become apparent from the following description of exemplary embodiments (with reference to the attached drawings).

### BRIEF DESCRIPTION OF THE DRAWINGS

FIG. 1 is a diagram that describes a configuration of an electronic timepiece according to the present embodiment.

FIG. 2 is a diagram that describes an example of input signal selection by a selector.

FIG. 3 is a diagram that describes switching between power generation and light emission operations by the selector.

FIG. 4 is a diagram that shows an example of alternative operation of a plurality of motors.

FIG. 5 is a diagram that shows an example of switching whether or not there is a selection of the motor.

FIG. 6A is a diagram that shows an example of function assignment to a second substrate.

FIG. 6B is a diagram that shows another example of function assignment to the second substrate.

### DETAILED DESCRIPTION

Hereinafter, embodiments of the present disclosure are described with reference to the drawings.

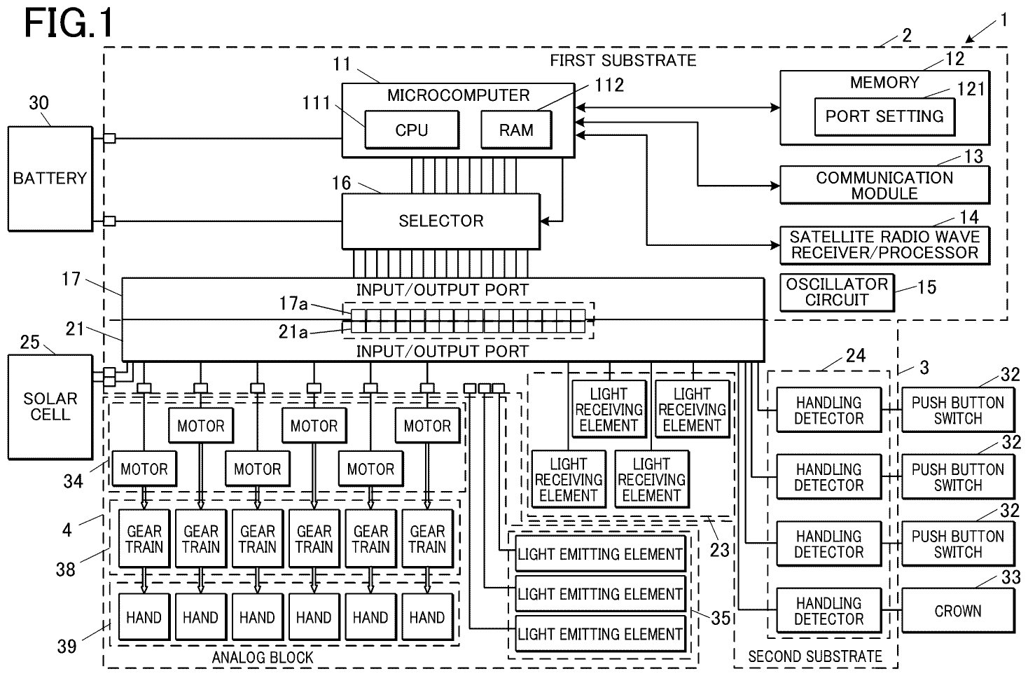

FIG. 1 is a diagram that describes a configuration of an electronic timepiece 1 according to the present embodiment.

The electronic timepiece 1 according to the present embodiment, for example, can display the time by a rotational motion of a plurality of hands.

The electronic timepiece 1 is equipped with a microcomputer 11 (controller), a memory 12, a communication module 13, a satellite radio wave receiver/processor 14, an oscillator circuit 15, a selector 16, input/output ports 17 and 21, a motor 34, a light receiving element 23, a handling detector 24, a solar cell 25, a push button switch 32, a crown 33, a gear train 38, a hand 39, and a battery 30.

The electronic timepiece 1 includes a first substrate 2 and a second substrate 3 in a housing.

Located on the first substrate 2 are the microcomputer 11, the memory 12 (storage), the communication module 13, the satellite radio wave receiver/processor 14, the oscillator circuit 15, the selector 16, and the input/output ports 17. The communication module 13 and the satellite radio wave receiver/processor 14 each have an antenna, if necessary.

The microcomputer 11 includes a CPU 111 (Central Processing Unit) and a RAM 112 (Random Access Memory), and the microcomputer 11 centrally controls the entire operation of the electronic timepiece 1. The CPU 111 is a processor that performs arithmetic operations. The CPU 111 may include a configuration and performance optimized for the purpose of the electronic timepiece 1, that is, for use in the electronic watch. The RAM 112 provides a working memory space for the CPU 111 and stores temporary data. In addition, the microcomputer includes a signal input/output terminal, etc. The input signal may include a clock signal by a signal of a certain frequency emitted by the oscillator circuit 15 or a signal of a frequency divided from this frequency.

The memory 12 includes a nonvolatile memory and stores setting data and other data. For example, the non-volatile memory is a flash memory. A port setting 121 (selection information) is stored in the memory 12. The port setting 121 stores information on signal wiring connected to each port of the microcomputer 11, as described below. Specifically, the port setting 121 stores which connection pad 17a in the input/output port 17 each port of the microcomputer 11 is connected to by the selector 16, and which configuration in the second substrate 3 such connection pad 17a corresponds to. In a case that a large amount of data is stored, the electronic timepiece 1 may include an additional memory. For example, in a case that the electronic timepiece 1 includes a sensor and stores sensor measurement data, etc., the additional memory may be located on the second substrate 3 in addition to the memory 12.

The communication module 13 controls communication, especially bidirectional communication, with external devices. Controllable bidirectional communication includes, for example, Bluetooth (registered trademark).

The satellite radio wave receiver/processor 14 identifies the current date and time and performs positioning based on radio waves from positioning satellites pertaining to the Global Navigation Satellite System (GNSS). The satellite radio wave receiver/processor 14 includes a receiver and an arithmetic processor. The receiver receives radio waves from positioning satellites and demodulates and decodes them. The arithmetic processor performs arithmetic processing related to obtaining the current date and time and identifying the current position based on signals from the positioning satellites obtained by the receiver. The arithmetic processor may include a separate CPU and RAM from the CPU 111 and the RAM 112.

The communication module 13 and the satellite radio wave receiver/processor 14 may be switched on and off, that is, may or may not be provided with power and operate, independently of the operation of the microcomputer 11.

The selector 16 switches signal lines to be connected to the microcomputer 11, etc., among each signal line of the second substrate 3 that is connected to each connection pad 17a via a connection pad 21a, based on control by the microcomputer 11. The signal lines of the first substrate 2 that are connected to the connection pad 17a do not necessarily all have to be connected to the microcomputer 11. There may be a signal line that is directly connected to a configuration other than the microcomputer 11.

The input/output port 17 includes a plurality of connection pads 17a as a first connection terminal (first connector). Each connection pad 17a is connected to the selector 16 by lines on the first substrate 2. Each connection pad 17a may be completely common. Alternatively, the connection pads 17a may be divided into multiple groups according to voltage or power that can be applied. Information on which signals pertaining to which configuration on the second substrate 3 can be input or output for each connection pad 17a of the input/output port 17 is stored in advance in the port setting 121. When the selection is switched, the current connection status is also stored and maintained in the port setting 121.

The motor 34, a light emitting element 35 and the light receiving element 23 (light detection element) are electrically connected to the connection pad or the terminal on the second substrate 3. The motor 34, the gear train 38, the hand 39, and the light emitting element 35 may be separately fixed to the second substrate 3 as an analog block 4 with peripheral devices fixed together in one piece, rather than being fixed directly to the second substrate 3. The motor 34 includes, for example, a stepping motor. The stepping motor rotates the gear train (wheel train mechanism) 38, which in turn rotates the hand 39 corresponding to the gear train 38. The light receiving element 23 is positioned so that the detected light amount for the light with the same intensity emitted by the light emitting element 35 corresponding to the light receiving element 23 is different when the first condition is met when the gear train 38 is in a specific rotational position and when the second condition is met when the gear train 38 is in a different rotational position than the first condition. The light emitting element 35 may be, for example, a Light Emitting Diode (LED). For example, the gear train 38 may block at least a portion of the incident light at a particular rotational position. A plurality of gears in the gear train 38 may have through holes. In particular, when a plurality of gears in partially overlapping positions in plan view are in a particular rotational position, the positions of the above through holes may overlap and transmit at least a portion of the incident light, thereby changing (increasing) the detected light amount. Alternatively, one gear in the gear train 38 may block at least a portion of the incident light, thereby changing the detected light amount. The light receiving element 23 may be in a position to receive the light emitted by the corresponding light emitting element 35, or may be in a position to receive outside light incident from outside the electronic timepiece 1. Here, six motors 34 (plural) and four light receiving elements 23 (plural) are shown. Accordingly, the electronic timepiece 1 includes six or more sets (plural) of gear trains 38 and hands 39. Some of the plurality of hands 39 may be rotated in conjunction by a single motor 34. There need not be one light receiving element 23 for each gear train 38 corresponding to each hand 39. For example, the light receiving element 23 may be able to commonly detect three positions such as every 120 degrees for three sets of gear trains 38 corresponding to these three hands 39. In this case, which gear train 38 was detected at a particular rotational position may be identified not only by a single detection, but also by an interval between multiple detections. When using gears to detect the rotational position of the gear train 38, the plurality of gears may all be configured to be detectable in a particular position. The above constitutes a hand position detection mechanism, i.e., the mechanism by which the gear train 38 detects a specific rotational position. Other configurations of the electronic timepiece 1 are not limited to these. The light receiving element 23 is, for example, a phototransistor. Alternatively, the light receiving element 23 may be a photodiode or the like.

The push button switch 32 and the crown 33 which penetrate through the housing are located in positions corresponding to the handling detector 24 on the second substrate 3. Three push button switches 32 are shown here, but the configuration is not limited to this. The push button switch 32 may include a shaft or a plate spring that is pressed against the shaft. The handling detector 24 may be an electrode or the like that contacts this leaf spring when it is pressed down on the shaft.

The solar cell 25 includes, for example, a solar panel that is located near an edge of the housing, that is exposed to the outside, and that generates electricity by receiving outside light. If the housing is substantially cylindrical in shape, the solar cell 25 may be a plurality of arc-shaped solar panels connected in series in a substantial circular array. Thus, under normal circumstances, power is generated as a result of incoming outside light, and the output voltage is the sum of the electromotive force of each solar panel. The solar cell 25 outputs a current corresponding to the difference between the output voltage and charging voltage of the battery 30.

According to the present embodiment, the solar panel of the solar cell 25 includes a plate-like structure in which a diode with a layer containing a compound semiconductor material such as InGaP as the power generating layer is sandwiched by electrodes on both sides. When a voltage (forward voltage) is applied to the diode structure of the solar panel, the solar panel emits light as an LED and functions as a lighting apparatus for the electronic timepiece 1. When the diode containing InGaP emits light, red light with a center wavelength of 664.5 nm is emitted. Alternatively, if AlInGaP is included in the diode as a compound semiconductor material, the wavelength becomes shorter than the above and the color becomes closer to orange. For the solar panel of the solar cell 25, it is possible to use any other compound semiconductor material that can provide adequate power generation efficiency during power generation and that can emit light at the desired wavelength as an LED.

In other words, the solar cell 25 is used as a second device to perform both power generation and light emission (multiple operations). The periods of these operations generally do not overlap, since the power generation operation occurs when outside light equal to or larger than the required intensity is incident and the light emission operation occurs when the outside light is insufficient.

The input/output port 21 includes a plurality of connection pads 21a as a second connection terminal (second connector). The connection pads 21a are equal to or more than the total number of connection pads or terminals to which the motor 34, the light receiving element 23, the light emitting element 35 and the solar cell 25 described above are connected respectively, and the handling detector 24. These input/output ports 21 may each be assigned multiple types of connection pads 21a, depending on the voltage applied, maximum power, etc. Furthermore, the dedicated connection pad 21a for specific applications, e.g., power supply applications, may be predetermined. Each connection pad 21a of the input/output port 21 is connected to each connection pad 17a of the input/output port 17 directly or through inter-connectors or other means. For this purpose, the first substrate 2 and the second substrate 3 may be layered. Depending on the number of components and the complexity of the lines, the first substrate 2 may be, but is not limited to, a laminated substrate. The second substrate 3 is a thin double-sided substrate, which reduces the thickness of the electronic timepiece 1, but is not limited to this.

The battery 30 supplies power to the microcomputer 11 and various parts. The battery 30 is a rechargeable battery and can be charged by the electricity generated by the solar cell 25. Both poles of the battery 30 are connected to the connection pad of the first substrate 2. The battery 30 may be fixed to or removable from the first substrate 2.

Thus, located on the first substrate 2 is the component that is not compatible with analog operations such as pointer (hand) display or manual handling, is not externally exposed, and does not need to be in a specific location with the exposed configuration. Specifically, the number and size of the component on the first substrate 2 does not vary depending on a model or other factors. The first substrate 2 may be positioned in the housing at any rotation angle determined for each model of the electronic timepiece 1, etc.

On the other hand, located on the second substrate 3 are mainly components that are externally exposed corresponding to analog operations such as pointer (hand) display or handling, or whose location is determined by the location of the externally exposed components. In addition to or instead of the above, located on the second substrate 3 are the components that each operate varying in number, size, etc. depending on the model, such as a hand position detection mechanism, etc. In other words, the connection terminal/pad for the peripheral device, etc. (operating part) that is the component that changes in number and position depending on the model, and that operates by signal connection with the microcomputer 11, etc., is concentrated on the second substrate 3. With this, the first substrate 2 may be commonly used for multiple models that utilize the same microcomputer 11, etc.

Next, the input/output ports 17 and 21 and the selector 16 are described.

As described above, the number of signals input and output via the input/output port 21 may vary depending on the number of motors 34, light receiving elements 23 and handling detectors 24 connected to the second substrate 3. However, the maximum number of each of these configurations to be connected is generally fixed, depending on the particular application, here as an electronic wristwatch, and the performance of the microcomputer 11.

The input/output port 17 includes about the maximum number of connection ports corresponding to each of the above signal types, etc. If the number of signal lines connected to the input/output port 21 is less than the maximum number, the excess connection port of the input/output port 17 can be left floating or grounded.

The selector 16 can selectively further connect some of the plurality of wires connected to the input/output port 17 to the microcomputer 11.

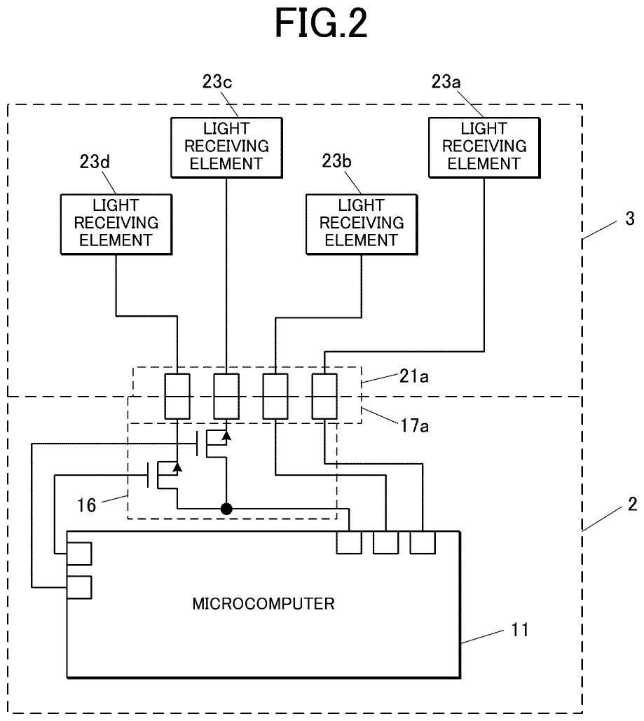

FIG. 2 is a diagram that describes an example of input signal selection by the selector 16. In each of the diagrams from FIG. 2 and after, electrical circuits and electrical components other than wiring necessary to explain the signal flow are omitted.

Four light receiving elements 23a to 23d are located on the second substrate 3 as the first devices according to the present embodiment. Among these light receiving elements 23a to 23d, the light detection signals by the light receiving elements 23c and 23d are alternatively (partially selectively) input to the microcomputer 11 by the control signal of the microcomputer 11 at the selector 16. If these light detection signals are analog signals, they are converted to digital signals by an analog-to-digital converter (ADC) before being input to the microcomputer 11. Alternatively, the ADC may be located on the microcomputer 11, and signal wiring pertaining to the light detection signal may be connected to the input terminal that is connected to the ADC among the input terminals of the microcomputer 11.

For example, the light receiving element 23d may be in a position where outside light enters without being shielded by the gear train 38 or other elements. The microcomputer 11 may obtain the threshold value based on the intensity of light received by the light receiving element 23d when outside light incident from a display surface side of the electronic timepiece 1 is not shielded. The threshold value may be set lower by a certain percentage than the intensity of light received by the light receiving element 23d. The threshold value may be set to increase or decrease according to the detection status of each of the subsequent hand positions. The switch by the selector 16 should be performed during the period when the hand 39 corresponding to the light receiving element 23c is not in rotational motion or the period when the position of the gear train 38 is not being detected, and the intensity of the outside light should be acquired by the light receiving element 23d. If the intensity of the light detected by the light receiving elements 23a to 23c is high compared to the threshold value obtained, each corresponding hand is identified as the detection position by the light receiving elements 23a to 23c.

The signal wiring for the light receiving elements 23a and 23b may be configured so as to enable switching with the light receiving elements that can be additionally provided. If the number of light receiving elements is less than the maximum increasable number and no selection is necessary, the light receiving elements 23a and 23b should be connected to the side of the selector 16 that operates in the initial state. Although only light receiving elements 23a to 23d are described here, the connection may also be switched by the selector 16 together with the light emitting element 35 corresponding to each of the light receiving elements 23a to 23d.

The selector 16 also switches the wiring according to the above switch between power generation and light emission operations in the solar cell 25.

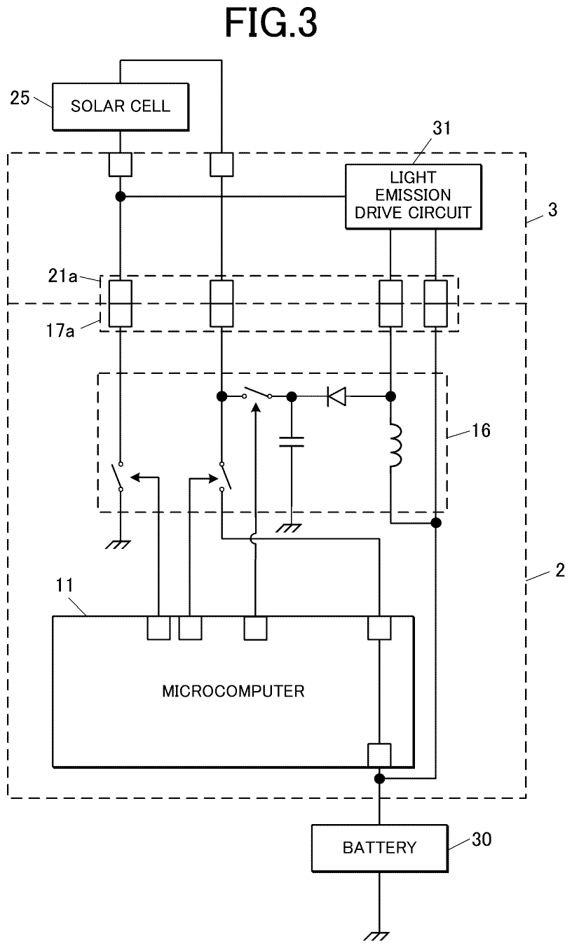

FIG. 3 is a diagram that describes switching between power generation and light emission operations by the selector 16.

In FIG. 3, the light emission drive circuit 31 is located on the second substrate 3. The light emission drive circuit 31 includes a circuit that applies the voltage necessary for light emission to the solar panel of the solar cell 25, receiving power supplied from the battery 30 when the solar cell 25 operates for light emission.

The selector 16 receives the control signal from the microcomputer 11 and selectively switches between power generation and light emission operations. Specifically, the selector 16 switches whether a first end, which is one end of the solar cell 25, is supplied with a supply voltage by the light emission drive circuit 31 or grounded. When this first end is grounded, the generated voltage output from the second end, which is opposite to the first end, is input to the microcomputer 11. If the generated voltage is higher than the output voltage of the battery 30, the microcomputer 11 applies the generated voltage to the battery 30 as the charging voltage. With this, the battery 30 is charged. On the other hand, when the first end is connected to the supply voltage from the light emission drive circuit 31, the second end is grounded through the light emission drive circuit 31. With this, a forward voltage is applied to the solar cell 25, and this allows the solar panel to emit light.

The solar cell 25 may be capable of switching the intensity of the light emission, e.g., the microcomputer 11 may be able to gradually change the light amount when the solar panel is turned on and off. Alternatively, the solar cell 25 may be capable of emitting light at the light amount corresponding to the intensity of the outside light detected by the light receiving element 23d above. In these cases, the control signal specifying a duty ratio of PWM (Pulse Width Modulation) may be separately output from the microcomputer 11 to the light emission drive circuit 31. In other words, input/output ports 17 and 21 may include connection pads 17a and 21a, respectively, which are connected to the wiring that sends signals related to PWM settings from the first substrate 2 to the second substrate 3.

Switching of these circuits at the selector 16 may be performed by FET. In this case, the FET may be set so that the power generated by the solar cell 25 can be supplied to the battery 30 even when the microcomputer 11 is not supplied with power and is stopped. Conversely, the circuitry of the selector 16 may be set so that the light emission of the solar cell 25 occurs only when the signal pertaining to a light emission command is output from the microcomputer 11.

The selector 16 may be able to connect any of the signal wires that connect to each of the multiple motors 34 to the wire that outputs drive signals from the microcomputer 11. This allows the microcomputer 11 to alternatively drive the motor 34.

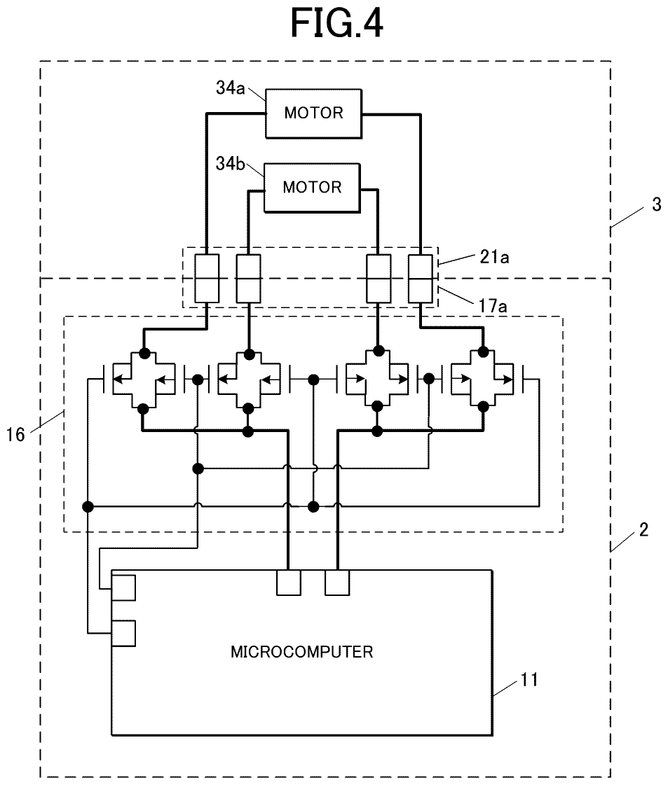

FIG. 4 is a diagram that shows an example of alternative operation of a plurality of motors 34a and 34b.

The selector 16 is connected to selectively output, under the control of the microcomputer 11, the drive control signal for the motor 34 output from the microcomputer 11 to one of the plurality of motors 34a and 34b. The plurality of motors 34a and 34b correspond to the first device according to the present embodiment. In other words, two of the four total signal lines connecting to the two motors 34a and 34b are selectively connected to the microcomputer 11 by the selector 16. With this, the operation of either the motor 34a or 34b is selectively controlled by the microcomputer 11. The arrangement and circuitry of the FET for selection is not limited to those illustrated here. In addition to the above, it may be possible to supply a separate signal to stop the motors 34a and 34b.

Similar to the example in FIG. 2, regarding signal wiring for the other motor, the selector 16 may include a circuit in which one of the two motors is selectively connected to the microcomputer 11. For motors that are less than the maximum increased number of motors and do not need to be selected, they may be connected to the side that is initially connected to the microcomputer 11. The connection pad 17a on the side where the selection is switched to this motor does not have to be connected to the second substrate 3. The connection pad 17a may be in contact with an insulation layer of the second substrate 3.

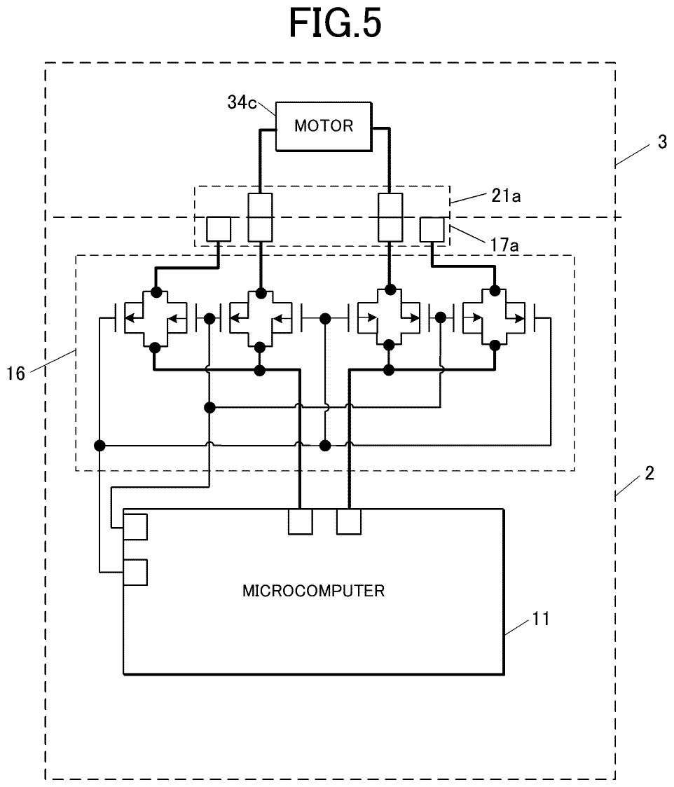

FIG. 5 is a diagram that shows an example of switching whether or not there is selection of the motor 34c.

The selector 16 may switch, under the control of the microcomputer 11, whether or not the drive control signal for the motor 34 output from the microcomputer 11 is output to the motor 34c. Under normal circumstances, the selector 16 should be switched to enable the motor 34c to be driven, and the drive control signal itself should be output from the microcomputer 11 as necessary. However, the selector 16 may be switched to not select the motor 34c. If the selector 16 is wired to include such switching, the microcomputer 11 can switch between a first state in which the maximum number of motors 34 that can be selected by the selector 16 is selected and a second state in which some of the motors 34 are selected. Some of the motors 34 here can include zero if there is no wiring where one of the motors 34 is always selected such as in FIG. 4.

The selector 16 may have all or any two of the configurations shown in FIG. 2 to FIG. 5 above, or only one of them. If a situation in which both the solar cell 25 emits light and the LED is separate from the solar cell 25 is assumed, the selector 16 may include a path to emit light for the LED separate from the path where the solar cell 25 operates to generate electricity.

If the electronic watch 1 shown in FIG. 4 and the electronic watch 1 shown in FIG. 5 are separate electronic timepieces, each can have a common first substrate 2 and second substrates 3 and 3 different from each other. In other words, the electronic watch 1 in FIG. 4 has an analog block 4 with two built-in motors 34a and 34b, and a corresponding second substrate 3 with connection pads 21a corresponding to the motors 34a and 34b, respectively. The electronic watch 1 in FIG. 5 has an analog block 4 with one built-in motor 34c, and a corresponding second substrate 3 with the connection pad 21a corresponding to the motor 34c. The electronic watch 1 in FIG. 4 and the electronic watch 1 in FIG. 5 can be different models of a common type of electronic timepiece, e.g., an electronic wristwatch.

The first substrate 2 includes connection pads 17a that can be connected to the two connection pads 21a for the motor 34. With this, the first substrate 2 can be used in a state connected with any of these second substrates 3 and 3 in different electronic timepieces 1 and 1. The selector 16 of the first substrate 2 can switch, under the control of the microcomputer 11, whether or not the drive control signal for the motor 34 output from the microcomputer 11 is output to the two motors 34a and 34b or the single motor 34c. In other words, in the electronic timepiece 1 shown in FIG. 4, the microcomputer 11 can selectively operate the maximum number of motors that can be selected by the selector 16, in this case, the two motors 34a and 34b. On the other hand, in the electronic timepiece 1 shown in FIG. 5, the microcomputer 11 can selectively operate the maximum number of motors that can be selected by the selector 16, in this case, the number smaller than two, that is, the one motor 34c.

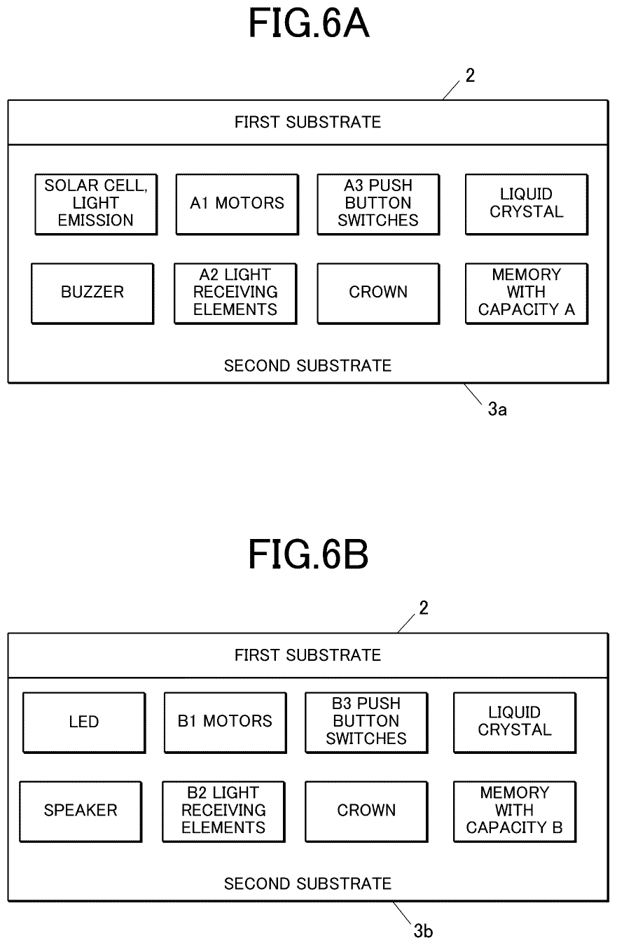

FIG. 6A and FIG. 6B are diagrams that show examples of function assignment to the second substrate.

As described above, different second substrates 3a and 3b corresponding to models with different functions can be combined to a common first substrate 2.

As shown in FIG. 6A, the following may be connected to the second substrate 3a, for example, the solar cell that can emit light, A1 motors, A2 light receiving elements, A3 push button switches, a crown, a buzzer, a liquid crystal display screen, and a memory with capacity A. On the other hand, as shown in FIG. 6B, the following may be connected to the second substrate 3b, for example, LED, B1 motors, B2 light receiving elements, B3 push button switches, a crown, a speaker, a liquid crystal display screen, and a memory with capacity B.

The number of signal lines connected between the second substrates 3a and 3b and the first substrate 2 can vary due to differences in the number of components shown by A1, A2, A3 and the number of components shown by B1, B2, B3, etc. The input/output ports 17 is to have the number of connection pads so as to be compatible regardless of the type of the second substrate 3a, 3b, etc. Each connection pad 17a of the input/output port 17 may be connected to the selector 16 to be arbitrarily selected to the extent that they can be handled in common, and with this, may be connected to the microcomputer 11 and other parts of the system.

As described above, the electronic timepiece 1 according to the present embodiment includes a first substrate 2 and a second substrate 3. The first substrate 2 includes the plurality of connection pads 17a, the microcomputer 11, and the selector 16 that switches the connection between the connection pads 17a and the microcomputer 11. The second substrate 3 includes a plurality of connection pads 21a that are connected to a plurality of operating parts (peripheral devices) that each perform a certain operation. The connection pads 21a are connected to each of the connection pads 17a. The selector 16 switches the connection pad 17a that is connected to the microcomputer 11 based on the control of the microcomputer 11.

In such an electronic timepiece 1, the connection terminals for peripheral devices, which can vary in number and arrangement for each model, are separated on the second substrate 3, which is separate from the first substrate 2 that contains the basic structure such as the microcomputer 11. Therefore, for models that can use the same microcomputer 11, only the second substrate 3 should be redesigned according to design and function while keeping the first substrate 2 common. The fact that the first substrate 2 includes the selector 16 allows switching which of the signal wires pertaining to each peripheral device on the second substrate 3 is connected to the microcomputer 11 and other devices. This means that the electronic timepiece 1 does not require the microcomputer 11 to simultaneously handle all of the numbers and contents of the components on the second substrate 3 that may be changed. Since the microcomputer 11 controls the switching of connections by the selector 16, dynamic switching during the operation of the electronic timepiece 1 is possible. Therefore, the electronic timepiece 1 can flexibly expand the configurations (peripheral devices) that can be controlled by the microcomputer 11, allowing common use of the first substrate 2 in multiple models.

The peripheral devices may include at least one of the following, the motor 34, the light receiving element 23, and the solar cell 25 that can emit light or the light emitting element 35 such as LED. These are prone to change in number and position due to various design and function changes in the electronic timepiece 1 that displays by multiple hands. These connection portions could be flexibly designed on the second substrate 3, and these signals could simply be sent via the input/output port 17 to the first substrate 2 with common specifications. With this, the design of the first substrate 2 does not have to be changed and it is possible to develop and manufacture models of the electronic timepiece 1 with a different design and function with less effort than conventional methods.

Moreover, a plurality of first devices of the same type may be included as the peripheral device. The microcomputer 11 may use the selector 16 so that the microcomputer 11 can be selectively connected to some of the plurality of first devices. That is, the electronic timepiece 1 can sequentially switch the connection of the signal lines with the microcomputer 11 as long as the peripheral devices of the same type do not operate simultaneously. With this, the microcomputer 11 can perform control to operate more first devices in parallel. Therefore, it is possible to easily accommodate peripheral devices equal to or more than the number of input/output terminals of the microcomputer 11.

The microcomputer 11 may be able to switch by using the selector 16 between the first state in which the maximum number of the same type of first devices connected to the microcomputer 11 via the connection pad 17a and the selector 16 are operated, and a second state in which a number smaller than the maximum number of the same type of identical first devices are operated. That is, the electronic timepiece 1 does not require multiple first devices to be connected to the microcomputer 11 at all times. In this way, the separation of some of the first devices from the microcomputer 11 can reduce power consumption, especially for electronic components that draw standby current even when not in operation. When the number of devices connected to the microcomputer 11 is larger than the number of terminals of the microcomputer 11, it is possible to operate each device without changing each configuration and wiring pattern of the microcontroller 11 and the first substrate 2 by temporarily disconnecting some first devices and operating other devices.

The electronic timepiece 1 may also include a plurality of hands 39 and a plurality of gear trains 38 that rotate the plurality of hands 39 in conjunction with each other. In this case, the peripheral devices include a plurality of motors 34 corresponding to a plurality of hands 39 and a plurality of light receiving elements 23. The plurality of motors 34 rotate the corresponding gear train 38, which in turn rotates the hands 39 corresponding to each of the plurality of gear trains 38. The plurality of light receiving elements 23 are configured so that the detected light amount for the light receiving element 23 is different between in a case that the first condition is met in which the plurality of gear trains 38 corresponding to each motor 34 are in a specific rotational position and in a case that the second condition is met in which the plurality of gear trains 38 are in a different rotational position than the first condition. The microcomputer 11 may be able to switch to selectively acquire the light detection signal from any of the multiple light receiving elements 23 by the selector 16.

If the operation of the hand 39 is intermittent, there is no need to continue the detection operation of the hand 39 except during operation. Even if the gear train 38 should be in a position where light is not detected, the detection operation can be somewhat omitted. Furthermore, the target for acquisition of the light detection signal by the microcomputer 11 may be switched promptly before the next operation of the plurality of hands 39 that operate at the same timing. Therefore, by appropriately switching and controlling the light receiving element 23 that is subject to receive the light detection signal, the electronic timepiece 1 can more efficiently detect the position of the gear train 38 using the light receiving element 23. The electronic timepiece 1 can flexibly increase or decrease the number of light receiving elements 23 as needed.

Moreover, a plurality of motors 34 may be included as the peripheral device. The microcomputer 11 may be able to switch by using the selector 16 between the first state in which, among the plurality of motors 34, the maximum number of the motors 34 connected to the microcomputer 11 are operated, and a second state in which a number smaller than the maximum number of the motors 34 are operated. In other words, each of the motors 34 may be excluded from the target of operation control by the microcomputer 11 at the timing when it is not necessary to operate the motors 34. This allows the electronic timepiece 1 to control the operation of the plurality of motors 34 more efficiently. The electronic timepiece 1 can flexibly increase or decrease the number of motors 34 as needed.

Moreover, a second device which is used for a plurality of operations may be included as the peripheral device. In this case, the microcomputer 11 may use the selector 16 to be able to switch to selectively perform any of the plurality of operations. In other words, the selector 16 can output to such second device the appropriate signal to cause one of the operations to be performed in response to the control signal. In particular, the selector 16 may not merely switch control signals to the second device, but may also be able to connect with the second device to change the signal wiring leading to the first substrate 2. The operation of the selector 16 allows the electronic timepiece 1 to flexibly switch the operation of the second device on the second substrate 3 without changing each element and wiring on the first substrate 2.

The second device may include the solar cell 25 with a power generation layer containing compound semiconductor materials that can emit light upon application of voltage. The microcomputer 11 may use the selector 16 to allow the solar cell 25 to switch between generating power and emitting light. Such configuration allows for the integration of some of the space and wiring for solar panels and LEDs that were previously required separately. Thus, the electronic timepiece 1 can efficiently control the operation of more peripheral devices.

The electronic timepiece 1 may also include the memory 12 that stores the selection information by the selector 16. The microcomputer 11 may control the signals of the signal wires connected to the selector 16, respectively, based on the selection information. In other words, at the manufacturing stage, the contents of operation according to the control signals of each connection pad 17a of the input/output port 17 and the corresponding destination peripheral device on the second substrate 3 are already determined. Therefore, by having the microcomputer 11 output operation control signals based on the selection information, the electronic timepiece 1 can easily make each peripheral device on the second substrate 3 perform the desired operation.

The present disclosure is merely an example and is not limited to the above embodiments. Various changes are possible.

For example, peripheral devices are not limited to the above configuration. For example, among the sensors that measure physical quantities, the sensor whose position must be determined according to the design may be connected to the second substrate 3. Instead of push button switches 32 and the like, other types of switches may be included, such as slide switches and rocker switches.

In addition, although it is possible to switch between a plurality of peripheral devices of the same type, the configuration is not limited to this. Even between peripheral devices of different types, if the signals are of the same type, for example, if the signals are all digital signals, the selector 16 may be used to switch the connection to the microcomputer 11.

The motor 34 is not limited to the stepping motor for rotating the gear train 38 and the pointer 39. For example, this could include a rotating motor with a weight to cause a notification operation by vibration.

The solar cell 25 may generate electricity by other materials and may not emit light due to other materials. In this case, the electronic timepiece 1 may have a separate light emitting element such as the LED or the like.

In the above, the satellite radio wave receiver/processor 14, which has no moving parts but whose antenna position and orientation can be considered with respect to other configurations, is described as being located on the first substrate 2. However, the satellite radio wave receiver/processor 14 may be located on the second substrate 3.

In the above, the electronic timepiece 1 is described as having a combination of one first substrate 2 and one second substrate 3, but it is not limited to this. The case in which multiple second substrates 3 are connected to one first substrate 2 is not excluded.

The above selector 16 could only switch between two signal wires, but it is not limited to this. The selector 16 may have a circuit configuration that allows switching between three or more signal wires to alternatively select one or to select some which is two or more.

Other specific components, configurations, connection relation of the signal lines, functions, operation contents, and the like as described in the above embodiments may be suitably changed without leaving the scope of the invention. The scope of the invention includes the scope of the claims and their equivalents.

What is claimed is:

1. An electronic timepiece comprising:
a first substrate that includes a plurality of first connection terminals, a processor, and a selector that switches a connection between the first connection terminals and the processor, and
a second substrate that includes a plurality of second connection terminals that are connected to a plurality of peripheral devices that each perform a certain operation,
wherein,
each of the second connection terminals is connected to each of the first connection terminals, and
the selector switches the first connection terminal that is connected to the processor based on control by the processor.

2. The electronic timepiece according to claim 1, wherein,
a plurality of first devices which are a same type are included in the peripheral device, and
the processor uses the selector to selectively connect the processor and some of the plurality of first devices.

3. The electronic timepiece according to claim 2, wherein the processor uses the selector to switch between a first state in which a maximum number of the same type of first devices connected to the processor through the first connection terminal and the selector are operated, and a second state in which the same type of first devices in a number smaller than the maximum number are operated.

4. The electronic timepiece according to claim 2, further comprising a plurality of hands and a plurality of gear trains that rotate the plurality of hands corresponding to each of the plurality of gear trains,
wherein,
the peripheral device includes a plurality of motors and a plurality of light detection elements,
the plurality of motors rotate the plurality of hands corresponding to each of the plurality of gear trains by rotating the plurality of gear trains corresponding to each of the plurality of motors,
the plurality of light detection elements are positioned so that a detected light amount is different between a case in which a first condition is met and a case in which a second condition is met, wherein the first condition is that each of the plurality of gear trains corresponding to each of the plurality of motors is in a specific rotational position, and the second condition is that the plurality of gear trains are in rotational positions different from the first condition, and
the processor uses the selector to switch so as to selectively acquire any light detection signal among the plurality of light detection elements.

5. The electronic timepiece according to claim 2, further comprising a plurality of hands and a plurality of gear trains that rotate the plurality of hands corresponding to each of the plurality of gear trains,
wherein,
a plurality of motors are included in a first device with a same type,
the plurality of motors rotate the plurality of hands corresponding to each of the plurality of gear trains by rotating the plurality of gear trains corresponding to each of the plurality of motors, and
the processor uses the selector to switch between a first state and a second state, the first state in which a maximum number of the motors connected to the processor through the first connection terminal and the selector are operated, and the second state in which the motors in a number less than the maximum number are operated.

6. The electronic timepiece according to claim 1, wherein,
the peripheral device includes a second device used for a plurality of operations, and
the processor uses the selector to selectively switch to perform any of the plurality of operations.

7. The electronic timepiece according to claim 6, wherein,
the second device includes a solar cell that includes a power generating layer including a compound semiconductor material that can emit light by applying voltage, and
the processor uses the selector to allow the solar cell to switch between power generation and light emission.

8. The electronic timepiece according to claim 1, further comprising a storage that stores selection information by the selector,
wherein the processor controls each signal of a signal wire connected to the selector based on the selection information.

9. The electronic timepiece according to claim 2, further comprising an analog block including, a plurality of hands, a plurality of gear trains that rotate the plurality of hands corresponding to each of the plurality of gear trains, and a plurality of light emitting elements,
wherein,
the peripheral device includes a plurality of motors and a plurality of light detection elements corresponding to each of the plurality of light emitting elements,
the plurality of motors rotate the plurality of hands corresponding to each of the plurality of gear trains by rotating the plurality of gear trains corresponding to each of the plurality of motors,
the plurality of light detection elements are positioned so that a detected light amount regarding an emission of light with a same intensity from the plurality of light emitting elements corresponding to each of the plurality of light detection elements is different between a case in which a first condition is met and a case in which a second condition is met, wherein the first condition is that each of the plurality of gear trains corresponding to each of the plurality of motors is in a specific rotational position, and the second condition is that the plurality of gear trains are in rotational positions different from the first condition, and
the processor uses the selector to selectively switch to allow any of the plurality of light emitting elements to emit light, and uses the selector to selectively switch to acquire any light detection signal among the plurality of light detection elements.

10. The electronic timepiece according to claim 2, further comprising an analog block including, a plurality of hands, a plurality of gear trains that rotate the plurality of hands corresponding to each of the plurality of gear trains, and a plurality of light emitting elements,
wherein,
a plurality of motors are included in a first device with a same type,
the plurality of motors rotate the plurality of hands corresponding to each of the plurality of gear trains by rotating the plurality of gear trains corresponding to each of the plurality of motors, and
the processor uses the selector to switch between a first state and a second state, the first state in which a maximum number of the motors connected to the processor through the first connection terminal and the selector are operated, and the second state in which the motors in a number less than the maximum number are operated.

11. The electronic timepiece according to claim 9, wherein,
the peripheral device includes a second device used for a plurality of operations, and
the processor uses the selector to selectively switch to perform any of the plurality of operations.

12. The electronic timepiece according to claim 11, wherein,
the second device includes a solar cell that includes a power generating layer including a compound semiconductor material that can emit light by applying voltage, and
the processor uses the selector to allow the solar cell to switch between power generation and light emission.

13. The electronic timepiece according to claim 10, wherein,
the peripheral device includes a second device used for a plurality of operations, and
the processor uses the selector to selectively switch to perform any of the plurality of operations.

14. The electronic timepiece according to claim 13, wherein,
the second device includes a solar cell that includes a power generating layer including a compound semiconductor material that can emit light by applying voltage, and
the processor uses the selector to allow the solar cell to switch between power generation and light emission.

15. The electronic timepiece according to claim 9, further comprising a storage that stores selection information by the selector,
wherein the processor controls each signal of a signal wire connected to the selector based on the selection information.

16. The electronic timepiece according to claim 10, further comprising a storage that stores selection information by the selector,
wherein the processor controls each signal of a signal wire connected to the selector based on the selection information.

17. The electronic timepiece according to claim 11, further comprising a storage that stores selection information by the selector,
wherein the processor controls each signal of a signal wire connected to the selector based on the selection information.

18. The electronic timepiece according to claim 17, further comprising a storage that stores selection information by the selector,
wherein the processor controls each signal of a signal wire connected to the selector based on the selection information.

19. The electronic timepiece according to claim 13, further comprising a storage that stores selection information by the selector,
wherein the processor controls each signal of a signal wire connected to the selector based on the selection information.

20. The electronic timepiece according to claim 19, further comprising a storage that stores selection information by the selector,
wherein the processor controls each signal of a signal wire connected to the selector based on the selection information.
